(19) United States
(12) Patent Application Publication
(10) Pub. No.: US 2024/0396379 A1
(43) Pub. Date: Nov. 28, 2024

(54) CONTROL METHOD, MODE SELECTION METHOD, TRANSMITTING MODULE, AND SYSTEM OF SIGNAL TRANSMISSION

(71) Applicant: CHENGDU CONVENIENTPOWER SEMICONDUCTOR CO., LTD., Chengdu (CN)

(72) Inventors: Yihong DAI, Chengdu (CN); Zufeng GUO, Chengdu (CN); Tun LI, Chengdu (CN)

(73) Assignee: CHENGDU CONVENIENTPOWER SEMICONDUCTOR CO., LTD., Chengdu (CN)

(21) Appl. No.: 18/292,338

(22) PCT Filed: Oct. 8, 2022
(86) PCT No.: PCT/CN2022/123776

§ 371 Date: Jan. 25, 2024

(30) Foreign Application Priority Data
Sep. 5, 2022 (CN) 202211080712.X

(51) Int. Cl. H02J 50/80; H02J 50/12

(52) U.S. Cl. CPC H02J 50/80; H02J 50/12

(57) ABSTRACT

Provided are control method, mode selection method, transmitting module, and system of signal transmission. The method includes the control unit selecting target control mode from the first control mode and the second control mode according to the working condition of transmitting module. If the first control mode is selected, the electromagnetic interference of transmitting coil is reduced by adjusting the working cycle of control signal to change synchronously, when the level value of first driving signal is valid and the second driving signal jumps once each time. If the second control mode is selected, the quick control of coil current is realized by controlling one control signal to maintain at low level, and the other control signal to switch to low level when the coil current is larger than first current threshold, or to switch to high level when the coil current is smaller than second current threshold.

### CROSS-REFERENCE TO RELATED APPLICATIONS

The present disclosure claims priority to Chinese patent Application No. 202211080712.X, filed with the Chinese Patent Office on Sep. 5, 2022, entitled “Control Method, Mode Selection Method, Transmitting Module and System of Signal Transmission,” the entire contents of which are incorporated herein by reference.

### TECHNICAL FIELD

The present disclosure relates to the technical field of signal transmission, and in particular to a control method, mode selection method, transmitting module, and system of signal transmission.

### BACKGROUND ART

In a signal transmission system, a transmitting module (Tx) generates a coil current signal through a full-bridge control, and the coil current signal is coupled to a receiving module (Rx) through a coil, so that an energy transmission and a signal transmission from the transmitting module to the receiving module can be realized.

Existing transmitting module and receiving module in the process of signal transmission often can only use a fixed signal transmission method to transmit the signal, which results in an inability to adjust the way that the transmitting module transmits signals to the receiving module according to an actual working condition of the transmitting module, so that scene compatibility of the whole transmitting module is not sufficient.

### SUMMARY

The objective of the present disclosure is to provide a control method, mode selection method, transmitting module, and system of signal transmission in response to deficiencies in prior art, so as to adjust the signal transmission method of a transmitting module according to an actual working condition of the transmitting module. Therefore, the working compatibility of the transmitting module is improved.

In order to realize the above objective, the technical solutions adopted by the embodiments of the present disclosure are as follows.

In a first aspect, the embodiments of the present disclosure provide a control method of signal transmission, which is applied to the transmitting module of the signal transmission system. The transmitting module includes a control unit, a full-bridge power unit, a transmitting coil, and a current detecting unit, wherein the transmitting coil is connected between midpoints of two bridge arms of the full-bridge power unit, and a current sampling point of the transmitting coil is connected to the control unit through the current detecting unit. The method comprises:
producing and outputting two control signals by the control unit according to two driving signals, and controlling the full-bridge power unit according to the two control signals to generate a coil current by the transmitting coil, wherein frequencies of the two control signals are higher than the two driving signals, and duty ratios of the two control signals are different; when a level value of the first driving signal is valid, a working cycle of the two control signals changes once synchronously when a second driving signal jumps once each time;
outputting an overcurrent signal to the control unit when the current detecting unit detects that the transmitting coil is in overcurrent; and
switching duty ratios of the two control signals by the control unit according to the overcurrent signal, and reducing the coil current according to the switched two control signals to adjust a signal to be transmitted.

Optionally, the step of producing and outputting two control signals by the control unit according to two driving signals comprises:
producing and outputting the two control signals by the control unit, when a level value of the first driving signal is valid and the second driving signal is at a low level, wherein a duty ratio of a first control signal is larger than a duty ratio of a second control signal.

Optionally, the step of producing and outputting the two control signals by the control unit, when the level value of the first driving signal is valid and the second driving signal is at a low level, comprises:
producing and outputting the two control signals by the control unit according to different working cycles, during a plurality of periods when the level value of the first driving signal is valid and the second driving signal is at a low level.

Optionally, the step of producing and outputting the two control signals by the control unit according to the two driving signals comprises:
producing and outputting the two control signals by the control unit when the level value of the first driving signal is valid and the second driving signal is at a high level, wherein the duty ratio of the first control signal is smaller than the duty ratio of the second control signal.

Optionally, the step of producing and outputting the two control signals by the control unit, when the level value of the first driving signal is valid and the second driving signal is at a high level, comprises:
producing and outputting the two control signals by the control unit according to different working cycles, during a plurality of periods when the level value of the first driving signal is valid and the second driving signal is at a high level.

In a second aspect, the embodiments of the present disclosure further provide the other control method of signal transmission, which is applied to a transmitting module in the signal transmission system, wherein the transmitting module includes: a control unit, a full-bridge power unit, a transmitting coil, and a current detecting unit, wherein the transmitting coil is connected between midpoints of two bridge arms of the full-bridge power unit, and a current sampling point of the transmitting coil is connected to the control unit through the current detecting unit. The method comprises:
producing and outputting two control signals by the control unit according to two driving signals, and controlling the full-bridge power unit according to the two control signals to generate the coil current by the transmitting coil, wherein when the level value of the first driving signal is valid and the second driving signal jumps every time, an initial level of the two control signals changes once;
outputting the overcurrent signal to the control unit when the current detecting unit detects that the coil current is larger than a first current threshold;
controlling the control signal of the high level to jump to the low level by the control unit according to the overcurrent signal, maintaining a level of the control signal of the low level unchanged, and controlling the full-bridge power unit to reduce the coil current according to new two control signals to adjust the signal to be transmitted;
outputting an undercurrent signal to the control unit when the current detecting unit detects that the coil current drops below a second current threshold; and
controlling the control signal which jumps to the low level to jump to the high level again by the control unit according to the undercurrent signal, maintaining the control signal of the low level at the low level continuously; and controlling the full-bridge power unit to increase the coil current according to the new two control signals to adjust the signal to be transmitted again.

Optionally, when the level value of the first driving signal is valid and the second driving signal is at the low level, the first control signal of the two control signals is at a high level and the second control signal is at a low level. The step of controlling a level jumping of the control signal of high level by the control unit according to the overcurrent signal, and maintaining the level of the control signal of the low level unchanged, comprises:
controlling the first control signal to jump to the low level by the control unit according to the overcurrent signal, maintaining the low level of the second control signal; and
the step of controlling the control signal which jumps to the low level to jump to the high level again by the control unit according to the undercurrent signal, and maintaining the control signal of the low level at the low level continuously, comprises:
controlling the first control signal to jump to the high level again by the control unit according to the undercurrent signal, maintaining the second control signal at the low level continuously.

Optionally, when the level value of the first driving signal is valid and the second driving signal is at the high level, the first control signal of the two control signals is at the low level and the second control signal is at the high level. The step of controlling the level jumping of the control signal of high level by the control unit according to the overcurrent signal, maintaining the level of the control signal of the low level unchanged, comprises:
controlling the second control signal to jump to the low level by the control unit according to the overcurrent signal, maintaining the first control signal at the low level; and
the step of controlling the control signal which jumps to the low level to jump to the high level again by the control unit according to the undercurrent signal, and maintaining the control signal of the low level at the low level continuously, comprises:
controlling the second control signal to jump to the high level again by the control unit according to the undercurrent signal, and maintaining the first control signal at the low level continuously.

In a third aspect, the embodiments of the present disclosure further provide a selection method of signal transmission control mode, which is applied to the control unit in the transmitting module, wherein the transmitting module includes: the control unit, the full-bridge power unit, the transmitting coil, and the current detecting unit. The transmitting coil is connected between the midpoints of two bridge arms of the full-bridge power unit, and the current sampling point of the transmitting coil is connected to the control unit through the current detecting unit; the signal transmission control mode comprises: a first control mode and a second control mode; and the method comprises:
selecting a target control mode from the first control mode and the second control mode by the control unit according to the working condition of the transmitting module, wherein
when the target control mode is the first control mode, the control unit is configured to perform any one of the control methods of signal transmission described in the first aspect above; and when the target control mode is the second control mode, the control unit is configured to perform the control method of signal transmission described in any one of the second aspect above.

In a fourth aspect, the embodiments of the present disclosure further provide a transmitting module, wherein the transmitting module includes: the control unit, the full-bridge power unit, the transmitting coil, and the current detecting unit. The transmitting coil is connected between the midpoints of two bridge arms of the full-bridge power unit, and the current sampling point of the transmitting coil is connected to the control unit through the current detecting unit, and the transmitting module is configured to perform any one of the control methods of signal transmission as described in the first aspect or to perform any one of the control methods of signal transmission as described in the second aspect.

In a fifth aspect, the embodiments of the present disclosure further provide a signal transmission system, wherein the signal transmission system includes: a receiving module and the transmitting module as described in the fourth aspect.

The beneficial effects of the present disclosure are as follows.

The present disclosure provides a control method, mode selection method, transmitting module, and system of signal transmission. The provided two control modes respectively perform two transmission control methods, wherein one of the transmission control methods can reduce electromagnetic interference during the signal transmission, and the other transmission control method can quickly respond to the change of the coil current in the transmitting coil, so as to adjust the current of the coil and ensure the stable transmission of the signal. By using a mode selection method based on the working condition of the transmission module, the target transmission control method is selected to enhance the working compatibility of the transmitting coil.

### BRIEF DESCRIPTION OF DRAWINGS

In order to more clearly illustrate the technical solutions of the embodiments of the present disclosure, the drawings used in the embodiments will be briefly introduced below. It should be understood that the following drawings only show certain embodiments of the present disclosure, and therefore should not be regarded as a limitation of the scope. For persons of ordinary skill in the art, other relevant drawings can be obtained from these drawings without inventive effort.

FIG. 1 shows a structure schematic diagram of a transmitting module provided by the embodiments of the present disclosure;

FIG. 2 shows a schematic circuit diagram of a transmitting module provided by the embodiments of the present disclosure;

FIG. 3 shows an oscillogram of a conventional full-bridge driving control signal;

FIG. 4 shows a schematic diagram of selecting a control mode of signal transmission provided by the embodiments of the present disclosure;

FIG. 5 shows a schematic flow diagram of a control method of signal transmission provided by the embodiments of the present disclosure;

FIG. 6 shows a schematic flow diagram of another control method of signal transmission provided by the embodiments of the present disclosure;

FIG. 7 shows an oscillogram of the first control signal provided by the embodiments of the present disclosure;

FIG. 8 shows a schematic flow diagram of another control method of signal transmission provided by the embodiments of the present disclosure;

FIG. 9 shows an oscillogram of the second control signal provided by the embodiments of the present disclosure;

FIG. 10 shows an oscillogram of the third control signal provided by the embodiments of the present disclosure;

FIG. 11 shows a flow diagram of another control method of signal transmission provided by the embodiments of the present disclosure;

FIG. 12 shows an oscillogram of the fourth control signal provided by the embodiments of the present disclosure;

FIG. 13 shows an oscillogram of the fifth control signal provided by the embodiments of the present disclosure; and

FIG. 14 shows an oscillogram of the sixth control signal provided by the embodiments of the present disclosure.

### DETAILED DESCRIPTION OF EMBODIMENTS

In order to make the objectives, technical solutions, and advantages of the embodiments of the present disclosure clearer, the technical solutions of the embodiments of the present disclosure will be described clearly and completely as follows in conjunction with the drawings of the embodiments of the present disclosure. It is clear that the described embodiments are partial embodiments of the present disclosure and not all of the embodiments.

Therefore, the following detailed description of embodiments of the present disclosure provided by the drawings is not intended to limit the protective scope of the present disclosure, but only to represent the selected embodiments of the present disclosure. Based on the embodiments of the present disclosure, all the other embodiments obtained by any person ordinarily skilled in the art without inventive effort shall fall within the scope of protection of the present disclosure.

In the description of the present disclosure, it should be noted that the orientation or positional relationship indicated by the terms “up”, “down”, etc. is based on the orientation or positional relationship shown in the drawings or the orientation or positional relationship in which the product of the present disclosure is customarily placed when used. They are used only for the purpose of facilitating the description of the present disclosure and simplifying the description and are not to indicate or imply that the device or element referred to must have a particular orientation, or be constructed and operated in the particular orientation, and therefore cannot be understood as a limitation of the present disclosure.

Furthermore, the terms in the specification and claims of the present disclosure and in the drawings foregoing, such as “first”, “second”, etc., are used to distinguish similar objects and are not used to describe a particular order or sequence. It should be understood that the data used in such ways can be interchanged where appropriate, so that the embodiments of the present disclosure described herein can be implemented in orders other than those illustrated or described herein. Additionally, the terms, such as “include” and “comprise” and any variations thereof, are intended to cover non-exclusive inclusion, e.g., a process, method, system, product, or apparatus including a series of steps or units are not to be limited as the steps or units that are clearly listed but can include other steps or units that are not clearly listed or that are inherent to the process, method, product or apparatus.

It should be noted that features in the embodiments of the present disclosure can be combined with each other without conflict.

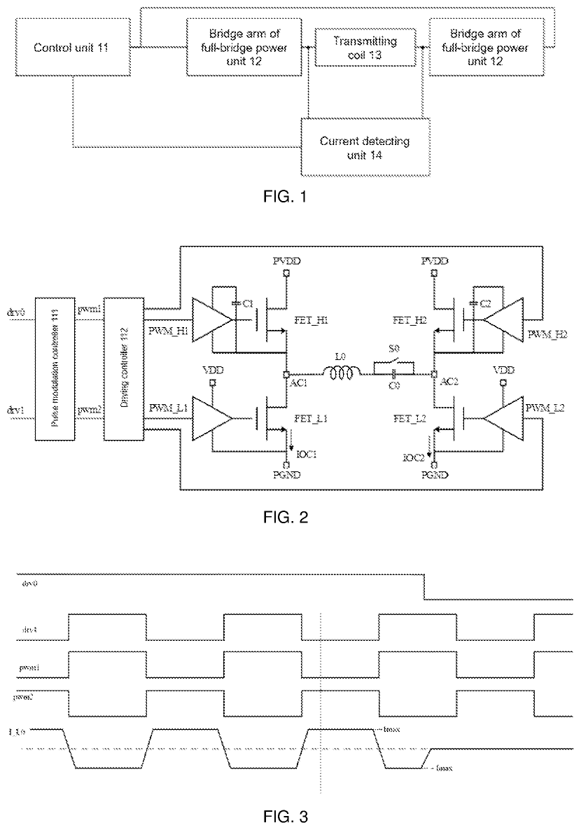

Referring to FIG. 1, it shows the structure schematic diagram of a transmitting module provided by the embodiments of the present disclosure. As shown in FIG. 1, the transmitting module includes a control unit 11, a full-bridge power unit 12, a transmitting coil 13, and a current detecting unit 14.

The control unit 11 is connected to a control end of the full-bridge power unit 12, the transmitting coil 13 is connected between the midpoints of the two bridge arms of the full-bridge power unit 12, the current sampling point of the transmitting coil 13 is connected to the control unit 11 through the current detecting unit 14, and the current sampling points of the transmitting coil 13 are the midpoints of the bridge arms of the two bridge arms of the full-bridge power unit 12.

In one possible embodiment, referring to FIG. 2, it shows the circuit schematic diagram of the transmitting module provided by the embodiments of the present disclosure. As shown in FIG. 2, the control unit 11 includes a pulse modulation controller 111, a driving controller 112, and a following controller 113. The pulse modulation controller 111 is configured to receive the driving signals drv0 and drv1 and to generate control signals PWM1 and PWM2 according to the driving signals drv0 and drv1. The driving controller 112 is connected to the pulse modulation controller 111 to generate switching signals PWM_H1 and PWM_L1 according to the control signal PWM1, and to generate switching signals PWM_H2 and PWM_L2 according to the control signal PWM2. The following controller 113 respectively transmits the four switching signals to the control end of the full-bridge power unit 12.

The full-bridge power unit 12 includes a bridge arm composed of power switching tube FET_H1 and power switching tube FET_L1 and the other bridge arm composed of power switching tube FET_H2 and power switching tube FET_L2. The midpoint of the bridge arm composed of the power switching tubes FET_H1 and FET_L1 is AC1, and the midpoint of the bridge arm composed of the power switching tubes FET_H2 and FET_L2 is AC2. One end of the transmitting coil L0 is connected to the midpoint of bridge arm AC1, the other end of the transmitting coil L0 is connected to the midpoint of bridge arm AC2 via a capacitor C0, and a switch S0 is connected in parallel to two ends of capacitor C0.

One end of the capacitor C1 is connected to an emitter of the power switching tube FET_H1, and the other end of the capacitor C1 is connected to a power supply end of the following controller 113 corresponding to the power switching tube FET_H1. One end of the capacitor C2 is connected to an emitter of the power switching tube FET_H2, and the other end of the capacitor C2 is connected to a power supply end of the following controller 113 corresponding to the power switching tube FET_H2. When the power switching tube FET_H1 is conducted, the capacitor C1 supplies power to the power supply end of the following controller 113 corresponding to the power switching tube FET_H1 according to a source voltage of the power switching tube FET_H1. When the power switching tube FET_H2 is conducted, the capacitor C2 supplies power to the power supply end of the following controller 113 corresponding to the power switching tube FET_H2 according to a source voltage of the power switching tube FET_H2.

The source electrode of the power switching tube FET_L1 is configured as the first current sampling point of the transmitting coil and the source electrode of the power switching tube FET_L2 is configured as the second current sampling point of the transmitting coil. Two sampling input ends of the current detecting unit 14 are respectively connected to the two current sampling points to detect the currents of the first current sampling point or the second current sampling point. The output end of the current detecting unit 14 is connected to the control end of the pulse modulation controller 111 to output the overcurrent signal to the pulse modulation controller 111.

In a specific embodiment, the switch S0 and the capacitor S0 can also not be used, and the transmitting coil L0 is directly connected between the midpoints of bridge arms AC1 and AC2. When the transmitting module is required to be compatible with the application scenario of wireless charging, the switch S0 and the capacitor C0 can be added in parallel between the transmitting coil L0 and the midpoint of bridge arm AC2. As shown in FIG. 2, when the switch S0 is turned on, the transmitting module is configured to realize the energy transmission, that is to say, the transmitting module is configured to realize the wireless charging; and when the switch S0 is turned off, the transmitting module is configured to realize the signal transmission.

During the process the transmitting module and receiving module perform the signal transmission, when the electromagnetic interference exists in transmitting coil during the signal transmission process, it is required to reduce the electromagnetic interference by the signal transmission method. When the electromagnetic interference does not exist, it is required to quickly respond to changes of the coil current, so that a stable transmission of signal can be ensured. However, the prior transmission control method cannot be compatible with two modes, which makes it impossible to select an optimal control method of signal transmission according to the working condition of the transmitting module.

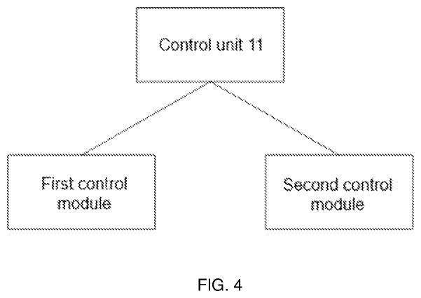

Based on this, the embodiment of the present disclosure provides a selection method of signal transmission control mode, which is applied to the control unit 11 in the transmitting module. Referring to FIG. 4, it shows the schematic diagram of selecting a signal transmission control mode provided by the embodiments of the present disclosure. As shown in FIG. 4, the signal transmission control mode includes the first control mode and the second control mode; and the method includes selecting the target control mode from the first control mode and the second control mode by the control unit according to the working condition of the transmitting module.

When the electromagnetic interference of the transmitting module is too large, the control unit can preferentially select the first control mode. The control unit performs the signal transmission method corresponding to the first control mode to reduce the electromagnetic interference in the signal transmission process by changing the working cycle of the control signal. When the electromagnetic interference of the transmitting module is smaller, the control unit can preferentially select the second control mode. The control unit performs the signal transmission method corresponding to the second control mode and adjusts the control signal in time according to the size of the coil current. Therefore, the control signal adjusts the coil current immediately when the coil current is overcurrent or undercurrent, which realizes a faster current control and ensures the stability of signal transmission.

It should be noted that the selection of the target control mode can be freely selected by the user. When the electromagnetic interference is too large, the user can preferentially select the first control mode, and when the electromagnetic interference is smaller, the user can preferentially select the second control mode. After the user selects the target control mode through the signal-transmitting equipment where the transmitting module is located, the control unit can receive a selection instruction of the target control mode, so as to determine the target control mode according to the selection instruction.

Furthermore, an electromagnetic interference detection device can also be provided in the signal-transmitting equipment. Therefore, the signal-transmitting equipment sends the electromagnetic interference signal to the control unit when the electromagnetic interference detection device detects that the electromagnetic interference from the transmitting module is too large, so that the control unit can preferentially select the first control mode according to the electromagnetic interference signal. The signal-transmitting equipment stops sending the electromagnetic interference signal to the control unit when the electromagnetic interference is smaller so that the control unit can preferentially select the second control mode.

Based on the transmitting module shown in FIG. 2, an existing control method of signal transmission is described below. Referring to FIG. 3, it shows the oscillogram of a conventional full-bridge drive control signal. As shown in FIG. 3, the control signal PWM1 or the control signal PWM2 is continuously at a high level condition during a period when drv1 maintains unchanged, which results in a longer conduction time of switching tubes of the full-bridge power unit 12. The current passing through the transmitting coil L0 is determined only by a direct current resistance of the transmitting coil L0 and the switch S0, so that the coil current cannot be flexibly controlled. Since the conduction time of the power switching tube FET_H1 and the power switching tube FET_H2 of the full-bridge power unit 12 is longer, the capacitors C1 and capacitor C2 need to be supported for a corresponding period, which restricts the application range of the control unit and the capacitors C1 and C2. The periods of control signals PWM1 and PWM2 maintain unchanged and the frequency of the control signal is constant, so that the electromagnetic interference problem may be generated during the process of signal transmission, which affects the stable transmission of the signal.

Based on this, for the transmitting module as shown in FIG. 1 and FIG. 2, the present disclosure intends to provide a control method of signal transmission, by which the frequency of the control signal is changed by changing the period of the driving signal, so as to reduce the electromagnetic interference during the signal transmission process, and to enhance the stability of the signal transmission.

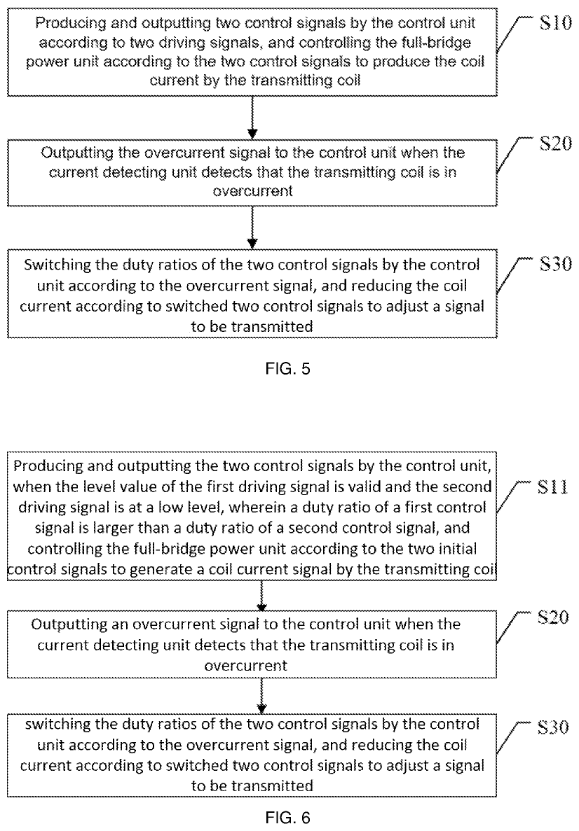

Based on the transmitting module provided in the above embodiments, the embodiments of the present disclosure provide a control method of signal transmission applied to the foregoing transmitting module, wherein the control method of signal transmission is the first control mode. Referring to FIG. 5, it shows the flow diagram of a control method of signal transmission provided by the embodiments of the present disclosure. As shown in FIG. 5, the method includes the following steps.
S10: producing and outputting two control signals by the control unit according to two driving signals, and controlling the full-bridge power unit according to the two control signals to generate the coil current by the transmitting coil.

In this embodiment, the two driving signals drv0 and drv1 received by the pulse modulation controller 111 of the control unit 11 are preset waveforms. When the first driving signal drv0 and the second driving signal drv1 are both at the low level, the transmitting module is not in the working condition. When the first driving signal drv0 is at the high level, that is to say, its level value is valid, and the second driving signal drv1 is switched to work between the high level and the low level, the transmitting module is in the working condition. When the transmitting module is in the working condition, the level value of the first driving signal drv0 is continuously valid. The second driving signal drv1 jumpily works between the high level and the low level, and the direction of the coil current in the transmitting coil changes once when the second driving signal drv1 jumps once each time.

The pulse modulation controller 111 generates two control signals PWM1 and PWM2 according to the received first driving signal drv0 and the second driving signal drv1, the frequency of the two control signals is higher than the frequency of the two driving signals, and the duty ratios of two control signals are different. The driving controller 112 in the control unit 11 generates the switching signals PWM_H1 and PWM_L1 according to the control signal PWM1 and generates the switching signals PWM_H2 and PWM_L2 according to the control signal PWM2, and respectively controls the power switching tubes FET_H1, FET_L1, FET_H2, and FET_L2 to be conducted or turned off through the switching signals PWM_H1, PWM_L1, PWM_H2, and PWM_L2, so that a voltage difference is formed between the midpoint of bridge arm AC1 and the midpoint of bridge arm AC2. Therefore, the coil current is generated in the transmitting coil. The transmitting module can send the signal to be transmitted through the coil current, and receive the signal to be transmitted through the receiving coil in the receiving module, which realizes the signal transmission between the device where the transmitting module is located and the device where the receiving module is located.
S20: outputting the overcurrent signal to the control unit when the current detecting unit detects that the transmitting coil is in overcurrent.

In the embodiment, the current detecting unit 14 detects the current of the first current sampling point or the second current sampling point, so as to output the overcurrent signal to the control unit when the overcurrent is detected.

When the voltage of the midpoint of bridge arm AC1 is larger than the voltage of the midpoint of bridge arm AC2, the transmitting coil generates the coil current from the midpoint of bridge arm AC1 to the midpoint of bridge arm AC2, and the current detecting unit 14 detects the current at the second current sampling point.

When the voltage of the midpoint of bridge arm AC1 is smaller than the voltage of the midpoint of bridge arm AC2, the transmitting coil generates the coil current from the midpoint of bridge arm AC2 to the midpoint of bridge arm AC1, and the current detecting unit 14 detects the current at the first current sampling point.
S30: switching the duty ratios of the two control signals by the control unit according to the overcurrent signal, and reducing the coil current according to the switched two control signals to adjust the signal to be transmitted.

In the embodiment, the pulse modulation controller 111 switches the duty ratio relationship of the control signals PWM1 and PWM2 according to the overcurrent signal. The driving controller 112 regenerates the switching signals PWM_H1 and PWM_L1 according to the switched control signal PWM1, and generates the switching signals PWM_H2 and PWM_L2 according to the switched control signal PWM2. The switching signals PWM_H1, PWM_L1, PWM_H2, and PWM_L2 respectively control the power switching tubes FET_H1, FET_L1, FET_H2, and FET_L2. The voltage formed by changing the midpoint of bridge arm AC1 and the midpoint of the bridge arm AC2 is adjusted to reduce the coil current.

When the level value of the first driving signal drv0 maintains valid and the second driving signal drv1 jumps once each time, the pulse modulation controller 111 synchronously changes the periods of the control signals PWM1 and PWM2 once, so as to realize a change of frequency of the control signals PWM1 and PWM2.

The transmitting module performs the foregoing process of S10-S30 both during the period before the second driving signal drv1 jumps and during the period after the second driving signal drv1 jumps. The periods of the control signal PWM1 and PWM2 are different during the period before the second driving signal drv1 jumps and during the period after the second driving signal drv1 jumps.

The control method of signal transmission provided in the foregoing embodiment generates two control signals of high frequency according to the two driving signals of low frequency, so as to control the transmitting coil to generate coil current. When the overcurrent in the transmitting coil is detected, the duty ratios of the two control signals are changed according to the overcurrent signal, wherein the duty ratio of the control signal with a large duty ratio is decreased and the duty ratio of the control signal with small duty ratio is increased, so as to decrease the current of the transmitting coil, thereby realizing the flexible control of the current in the transmitting coil. When the level value of one driving signal maintains valid and the level value of the other driving signal jumps once each time, the working cycles of the two control signals are synchronously modified once. Therefore, when the transmitting module works, the periods of the two control signals will be changed, so as to change the working frequencies of the two control signals. Through the use of control signals with different frequencies to control the transmitting module during the process of signal transmission, it is possible to effectively decrease the electromagnetic interference during the process of signal transmission.

Based on the foregoing embodiments, the embodiments of the present disclosure further provide another control method of signal transmission. Referring to FIG. 6, it shows the flow diagram of another control method of signal transmission provided by the embodiments of the present disclosure. As shown in FIG. 6, the step of producing and outputting two control signals by the control unit according to two driving signals in the foregoing S10 can include the following step.
S11: producing and outputting the two control signals by the control unit, when the level value of the first driving signal is valid and the second driving signal is at a low level, wherein the duty ratio of the first control signal is larger than the duty ratio of the second control signal.

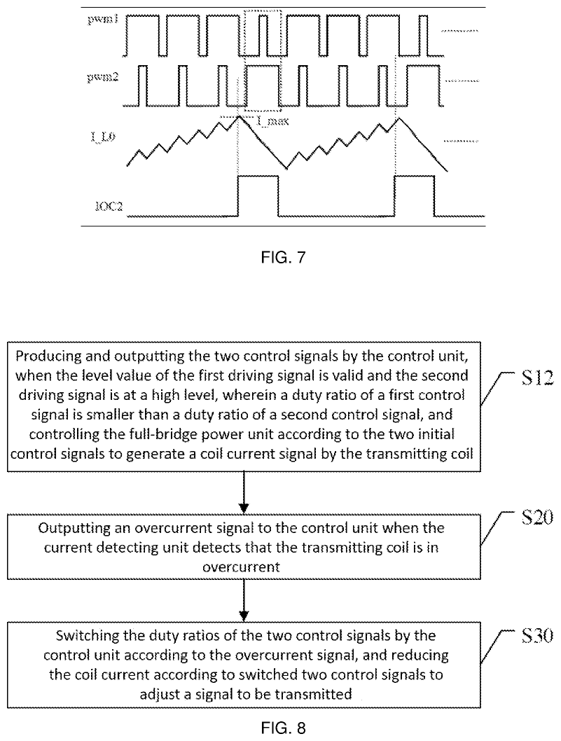

In the embodiment, referring to FIG. 7, it shows the oscillogram of the first control signal provided by the embodiments of the present disclosure. As shown in FIG. 7, when the driving signal drv0 is at the high level and the second driving signal drv1 is at the low level, the pulse modulation controller 111 generates the first control signal PWM1 and the second control signal PWM2 according to the first driving signal drv0 and the second driving signal drv1, wherein the duty ratio of the first control signal PWM1 is larger than the duty ratio of the second control signal PWM2. The driving controller 112 generates the two complementary switching signals PWM_H1 and PWM_L1 according to the first control signal PWM1, in order to control the power switching tube FET_H1 to be conducted or turned off according to the switching signal PWM_H1, and in order to control the power switching tube FET_L1 to be conducted or turned off according to the switching signal PWM_L1. The driving controller 112 generates the two complementary switching signals PWM_H2 and PWM_L2 according to the second control signal PWM2, in order to control the power switching tube FET_H2 to be conducted or turned off according to the switching signal PWM_H2, and in order to control the power switching tube FET_L2 to be conducted or turned off according to the switching signal PWM_L2. Since the duty ratio of the first control signal PWM1 is larger than the duty ratio of the second control signal PWM2, the current from the midpoint of bridge arm AC1 to the midpoint of bridge arm AC2 in the transmitting coil is generated.

When the coil current exceeds the threshold of current, the current detecting unit generates an overcurrent signal IOC2. The pulse modulation controller 111 switches the duty ratios of the two control signals according to the overcurrent signal IOC2, so that the duty ratio of the first control signal PWM1 is smaller than that of the second control signal PWM2. The voltage from the midpoint of bridge arm AC1 to the midpoint of bridge arm AC2 in the transmitting coil is formed, so that the current from the midpoint of bridge arm AC1 to the midpoint of bridge arm AC2 in the transmitting coil is decreased.

It should be noted that the current from the midpoint of bridge arm AC1 to the midpoint of bridge arm AC2 in the transmitting coil defined by the embodiment is a positive current, and the current from the midpoint of bridge arm AC2 to the midpoint of bridge arm AC1 is a negative current.

Based on the foregoing embodiments, the embodiment of the present disclosure also provides another control method of signal transmission. Referring to FIG. 8, it shows the flow diagram of another control method of signal transmission provided by the embodiment of the present disclosure. As shown in FIG. 8, the step of producing and outputting two control signals by the control unit according to two driving signals in the foregoing S10 can include the following step.
S12: producing and outputting the two control signals by the control unit, when the level value of the first driving signal is valid and the second driving signal is at a high level, wherein the duty ratio of the first control signal is smaller than the duty ratio of the second control signal.

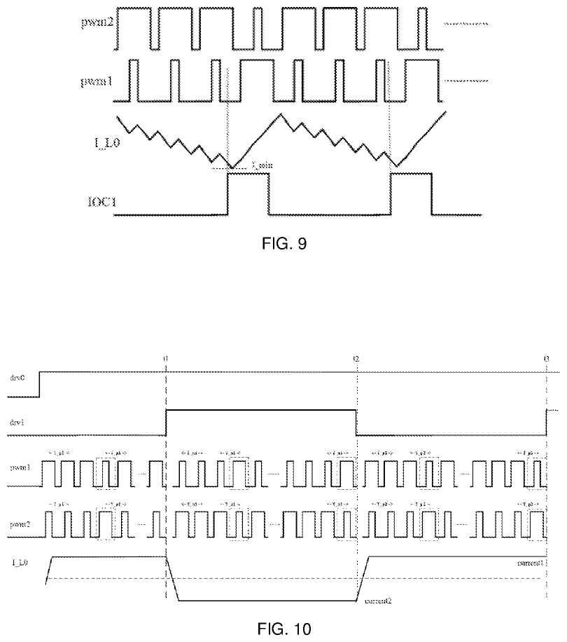

In the embodiment, referring to FIG. 9, it shows the oscillogram of the second control signal provided by the embodiment of the present disclosure. As shown in FIG. 9, when the first driving signal drv0 is at the high level and the second driving signal drv1 is at the high level, the pulse modulation controller 111 generates a first control signal PWM1, and a second control signal PWM2 according to the first driving signal drv0 and the second driving signal drv1, wherein the duty ratio of the first control signal PWM1 is smaller than the duty ratio of the second control signal PWM2. Therefore, the current from the midpoint of bridge arm AC2 to the midpoint of bridge arm AC1 in the transmitting coil is formed.

When the coil current exceeds the threshold of current, the current detecting unit generates the overcurrent signal IOC1. The pulse modulation controller 111 switches the duty ratios of the two control signals according to the overcurrent signal IOC1, so that the duty ratio of the first control signal PWM1 is larger than the duty ratio of the second control signal PWM2. The voltage from the midpoint of bridge arm AC1 to the midpoint of bridge arm AC2 in the transmitting coil is formed, so that the current from the midpoint of bridge arm AC2 to the midpoint of bridge arm AC1 in the transmitting coil is decreased.

It should be noted that, as shown in FIG. 7 and FIG. 9, when the duty ratio of PWM1 or PWM2 is not 100%, the power switching tube FET_H1 or the power switching tube FET_H2 does not continue to be conducted for a long period. Therefore, the period that capacitors C1 and C2 need to support does not last all the time, so the application range of the control unit and the capacitors C1 and C2 can be expanded.

In one possible embodiment, in the foregoing S11, the step of producing and outputting the two control signals by the control unit, when the level value of the first driving signal is valid and the second driving signal is at a low level includes:
producing and outputting the two control signals by the control unit according to different working cycles, during the plurality of periods when the level value of the first driving signal is valid and the second driving signal is at a low level.

In the foregoing S12, the step of producing and outputting the two control signals by the control unit, when the level value of the first driving signal is valid and the second driving signal is at a high level includes:
producing and outputting the two control signals by the control unit according to different working cycles, during the plurality of periods when the level value of the first driving signal is valid and the second driving signal is at a high level.

In the embodiment, when the first driving signal drv0 maintains the high level valid, during the process that the second driving signal drv1 jumps from the low level to the high level or jumps from the high level to the low level, the period of the two control signals changes once when the second driving signal drv1 jumps once each time, the duty ratio of the two control signals also changes once. Through generating different control signals with different periods in different periods of time, the frequencies of the control signal in different periods of time can be adjusted, so as to decrease the electromagnetic interference (EMI) during the process of transmitting.

Exemplarily, referring to FIG. 10, it shows the oscillogram of the third control signal provided by the embodiment of the present disclosure. As shown in FIG. 10, when the level value of the first driving signal is valid and the second driving signal is at the low level, the period of the two control signals is T_p1; when the second driving signal jumps to the high level, the period of two control signals is changed to T_n1; and when the second driving signal jumps to the low level again, the period of two control signals is changed to T_p2, so that the frequencies of the control signals in different periods are changed, so as to decrease the electromagnetic interference during the process of transmitting.

It should be noted that the periods of the two control signals are synchronously changed once following with each jump of the second driving signal, which are not limited to the three periods of T_p1, T_n1, and T_p2 in the embodiments, but are recursive with T_p1, T_n1, T_p2, T_n2, and so on. It should be noted that T_p1, T_n1, T_p2, T_n2, and so on are not equal to each other, wherein the embodiment can adopt pseudo-random modulation to randomly generate T_p1, T_n1, T_p2, T_n2, and so on.

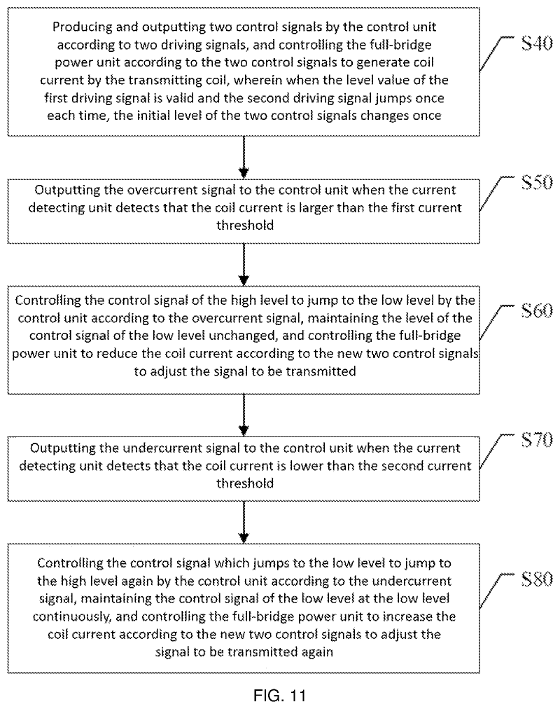

Based on the foregoing embodiments, the embodiment of the present disclosure further provides another control method of signal transmission, and the control method of signal transmission is the second control mode. Referring to FIG. 11, it shows the flow diagram of another control method of signal transmission provided by the embodiment of the present disclosure. As shown in FIG. 11, the method includes the following steps.
S40: producing and outputting two control signals by the control unit according to two driving signals, and controlling the full-bridge power unit according to the two control signals to generate coil current by the transmitting coil, wherein when the level value of the first driving signal is valid and the second driving signal jumps once each time, the initial level of the two control signals changes once.
S50: outputting the overcurrent signal to the control unit when the current detecting unit detects that the coil current is larger than the first current threshold.

In the embodiment, the first current threshold is provided. The current at the first current sampling point or the second current sampling point is detected by the current detecting unit 14, so as to output the overcurrent signal to the control unit when the coil current is detected to be larger than the first current threshold.
S60: controlling the control signal of the high level to jump to the low level by the control unit according to the overcurrent signal, maintaining the level of the control signal of the low level unchanged, and controlling the full-bridge power unit to reduce the coil current according to the new two control signals to adjust the signal to be transmitted.

In the embodiment, the control unit controls the control signal of the high level to jump to the low level according to the overcurrent signal, the level of the control signal of the low level maintains unchanged, so that lower tubes of the two bridge arms of the full-bridge power unit are conducted, so as to reduce the coil current.
S70: outputting the undercurrent signal to the control unit when the current detecting unit detects that the coil current is lower than the second current threshold.

In the embodiment, the second current threshold is provided. The current at the first current sampling point or the second current sampling point is detected by the current detecting unit 14, so as to output the undercurrent signal to the control unit when the coil current is detected to be smaller than the second current threshold.
S80: controlling the control signal which jumps to the low level to jump to the high level again by the control unit according to the undercurrent signal, maintaining the control signal of the low level at the low level continuously, and controlling the full-bridge power unit to increase the coil current according to the new two control signals to adjust the signal to be transmitted again.

In the embodiment, the control unit controls the control signal which jumps to the low level to jump to the high level again according to the undercurrent signal, the control signal of the low level maintains the low level continuously, so that the full-bridge power unit switches to the previous conduction state to increase the coil current.

In the wireless signal transmission method provided by the foregoing embodiment, through decreasing the coil current according to the control signal when the coil current is larger than the first current threshold, or increasing the coil current according to the control signal when the coil current is smaller than the second current threshold, the coil current can fluctuate between the first current threshold and the second current threshold, which avoids the occurrence of overcurrent or undercurrent, and thereby ensuring the stable transmission of the signal. By adjusting the control signal in time according to the magnitude of the coil current, the control signal adjusts the coil current immediately when the coil current is in overcurrent or undercurrent, which realizes a more rapid control of the current, thereby ensuring the stability of the signal transmission.

In an optional embodiment, when the level value of the first driving signal is valid and the second driving signal is at the low level, the first control signal of the two control signals is at the high level and the second control signal is at the low level. The foregoing S60 includes:
controlling the first control signal to jump to the low level according to the overcurrent signal by the control unit, and maintaining the second control signal at the low level.

The foregoing S80 includes:
controlling the first control signal to jump to the high level again according to the undercurrent signal by the control unit, and maintaining the second control signal at the low level.

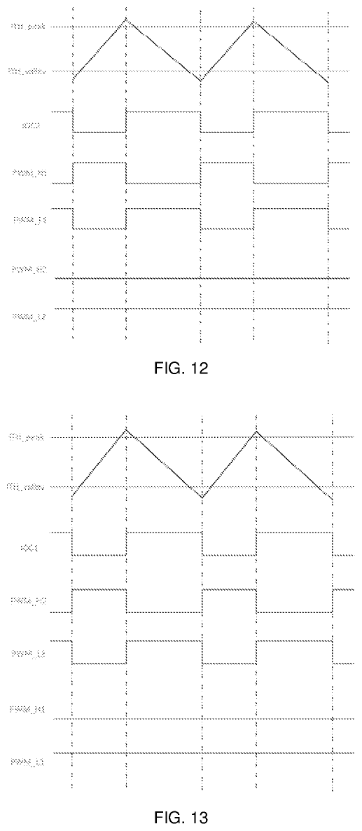

In the embodiment, referring to FIG. 12, it shows the oscillogram of the fourth control signal provided by the embodiment of the present disclosure. As shown in FIG. 12, when the first driving signal drv0 is at the high level and the second driving signal drv1 is at the low level, the first control signal PWM1 in the initial state is at the high level and the second control signal PWM2 in the initial state is at the low level. The driving controller 112 generates two complementary switching signals PWM_H1 and PWM_L1 according to the high level of the first control signal PWM1, wherein the switching signal PWM_H1 is at the high level and the switching signal PWM_L1 is at the low level. The driving controller 112 further generates two complementary switching signals PWM_H2 and PWM_L2 according to the low-level second control signal PWM2, wherein the switching signal PWM_H2 is at the low level and the switching signal PWM_L2 is at the high level.

Thereafter, the power switching tube FET_H1 is controlled to conduct according to the switching signal PWM_H1, the power switching tube FET_L1 is controlled not to conduct according to the switching signal PWM_L1, the power switching tube FET_H2 is controlled not to conduct according to the switching signal PWM_H2, and the power switching tube FET_L2 is controlled to conduct according to the switching signal PWM_L2. The voltage of the midpoint of bridge arm AC1 is larger than the voltage of the midpoint of bridge arm AC2, and the positive current is generated in the transmitting coil from the midpoint of bridge arm AC1 to the midpoint of bridge arm AC2.

When the positive current is larger than the first current threshold (ITH_peak), IOC2 is triggered to the high level. The control unit switches the first control signal PWM1 to the low level according to the IOC2, and the second control signal PWM2 maintains at the low level. Therefore, the switching signal PWM_H1 is switched to the low level, and the switching signal PWM_L1 is switched to the high level. The power switching tube FET_H1 and the power switching tube FET_H2 are not conducted, and the power switching tube FET_L1 and the power switching tube FET_L2 are conducted. The voltages of the midpoint of bridge arm AC1 and the midpoint of bridge arm AC2 are both pulled down to ground, so as to reduce the coil current generated by the transmitting coil until the positive current of the coil current is smaller than the second current threshold (ITH_valley).

During the process that the positive current of the transmitting coil is decreased from the first current threshold to the second current threshold, IOC2 is continuously at the high level. When the positive current is smaller than the positive second current threshold, IOC2 is switched to the low level. The control unit switches the first control signal PWM1 to the high level again according to the IOC2, and the second control signal PWM2 maintains at the low level. Therefore, the switching signal PWM_H1 is switched to the high level again, and the switching signal PWM_L1 is switched to the low level again. The power switching tube FET_H1 and the power switching tube FET_L2 are conducted, and the power switching tube FET_H2 and the power switching tube FET_L1 are not conducted. The voltage at the midpoint of bridge arm AC1 is larger than the voltage at the midpoint of bridge arm AC2, so as to increase the coil current generated by the transmitting coil until the positive current of the transmitting coil is larger than the first current threshold.

In another optional embodiment, when the level value of the first driving signal is valid and the second driving signal is at the high level, the first control signal of the two control signals is at the low level and the second control signal is at the high level. The foregoing S60 includes:
controlling the second control signal to jump to the low level according to the overcurrent signal by the control unit, and maintaining the first control signal at the low level.

The foregoing S80 includes:
controlling the second control signal to jump to the high level again according to the undercurrent signal by the control unit, and maintaining the first control signal at the low level.

In the embodiment, referring to FIG. 13, it shows the oscillogram of the fifth control signal provided by the embodiment of the present disclosure. As shown in FIG. 13, when the first driving signal drv0 is at the high level and the second driving signal drv1 is at the high level, the first control signal PWM1 in the initial state is at the low level and the second control signal PWM2 in the initial state is at the high level. The driving controller 112 generates two complementary switching signals PWM_H1 and PWM_L1 according to the low level of the first control signal PWM1, wherein the switching signal PWM_H1 is at the low level and the switching signal PWM_L1 is at the high level. The driving controller 112 further generates two complementary switching signals PWM_H2 and PWM_L2 according to the high level of the second control signal PWM2, wherein the switching signal PWM_H2 is at the high level and the switching signal PWM_L2 is at the low level.

Thereafter, the power switching tube FET_H1 is controlled not to conduct according to the switching signal PWM_H1, the power switching tube FET_L1 is controlled to conduct according to the switching signal PWM_L1, the power switching tube FET_H2 is controlled to conduct according to the switching signal PWM_H2, and the power switching tube FET_L2 is controlled not to conduct according to the switching signal PWM_L2. The voltage of the midpoint of bridge arm AC2 is larger than the voltage of the midpoint of bridge arm AC1, and the negative current is generated in the transmitting coil from the midpoint of bridge arm AC2 to the midpoint of bridge arm AC1.

When the absolute value of the negative current is larger than the first current threshold, IOC1 is triggered to the high level. The control unit switches the second control signal PWM2 to the low level according to the IOC1, and the first control signal PWM1 maintains at the low level. Therefore, the switching signal PWM_H2 is switched to the low level, and the switching signal PWM_L2 is switched to the high level. The power switching tube FET_H1 and the power switching tube FET_H2 are not conducted, and the power switching tube FET_L1 and the power switching tube FET_L2 are conducted. The voltages of the midpoint of bridge arm AC1 and the midpoint of bridge arm AC2 are both pulled down to ground, so as to reduce the coil current generated by the transmitting coil until the absolute value of the negative current of the coil current is smaller than the second current threshold.

During the process that the absolute value of the negative current of the transmitting coil is decreased from the first current threshold to the second current threshold, IOC1 is continuously at the high level. When the absolute value of the negative current is smaller than the second current threshold, IOC1 is switched to the low level. The control unit switches the second control signal PWM2 to the high level again according to the IOC1, and the first control signal PWM1 maintains at the low level. Therefore, the switching signal PWM_H2 is switched to the high level again, and the switching signal PWM_L2 is switched to the low level again. The power switching tube FET_H2 and the power switching tube FET_L1 are conducted, and the power switching tube FET_H1 and the power switching tube FET_L2 are not conducted. The voltage at the midpoint of bridge arm AC2 is larger than the voltage at the midpoint of bridge arm AC1, so as to increase the coil current generated by the transmitting coil until the absolute value of the negative current of the transmitting coil is larger than the first current threshold.

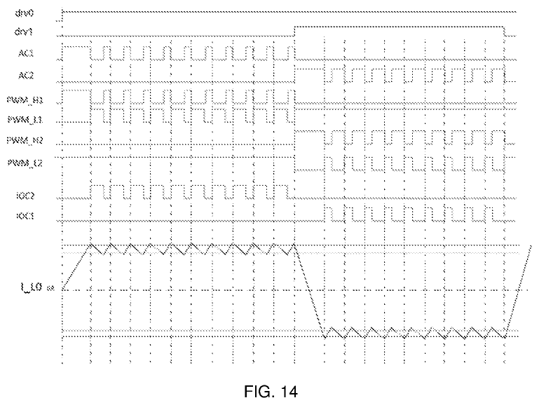

Exemplarily, referring to FIG. 14, it shows the oscillogram of the sixth control signal provided by the embodiment of the present disclosure. As shown in FIG. 14, after the second driving signal drv1 jumps, the level values of the two control signals are switched. The oscillogram of the second driving signal is consistent with that of FIG. 12 during the period that the second driving signal drv1 is at the low level, and FIG. 12 is equivalent to the partially enlarged oscillogram of a portion of FIG. 14 for the period when the second driving signal drv1 is at the low level. The oscillogram of the second driving signal is consistent with that of FIG. 13 during the period that the second driving signal drv1 is at the high level, and FIG. 13 is equivalent to the partially enlarged oscillogram of a portion of FIG. 14 for the period when the second driving signal drv1 is at the high level, and no more details in the oscillograms of FIG. 14 will be given herein.

Based on the foregoing embodiments, the present disclosure further provides a signal transmission system. The signal transmission system includes a receiving module and a transmitting module, wherein the circuit structure of the transmitting module is shown in FIG. 1 or FIG. 2, and the process of the control method of signal transmission realized by the transmitting module is as previously described, which will not be repeated herein.

The transmitting module is provided in the signal-transmitting equipment, and the receiving module is provided in the signal-receiving equipment, which includes at least one receiving coil. The receiving coil receives the electromagnetic signal transmitted by the transmitting coil to realize the signal transmission between the transmitting coil and the receiving coil.

The above are only specific embodiments of the present disclosure, but the scope of protection of the present disclosure is not limited herein. Any skilled person familiar with the technical field can easily think of changes or substitutions within the scope of the art disclosed in the present disclosure, all of which should be covered by the scope of protection of the present disclosure. Therefore, the scope of protection of the present disclosure shall be governed by the scope of protection of the claims.

1. A control method of signal transmission, applied to a transmitting module in a signal transmission system, wherein the transmitting module comprises: a control unit, a full-bridge power unit, a transmitting coil, and a current detecting unit, wherein the transmitting coil is connected between midpoints of two bridge arms of the full-bridge power unit, and a current sampling point of the transmitting coil is connected to the control unit through the current detecting unit; and the method comprises:
producing and outputting two control signals by the control unit according to two driving signals, and controlling the full-bridge power unit according to the two control signals to generate a coil current by the transmitting coil, wherein frequencies of the two control signals are higher than the two driving signals, and duty ratios of the two control signals are different; and when a level value of a first driving signal is valid and a second driving signal jumps once each time, a working cycle of the two control signals changes once synchronously;
outputting an overcurrent signal to the control unit when the current detecting unit detects that the transmitting coil is in overcurrent; and
switching the duty ratios of the two control signals by the control unit according to the overcurrent signal, and reducing the coil current according to switched two control signals to adjust a signal to be transmitted.

2. The method according to claim 1, wherein the step of producing and outputting two control signals by the control unit according to two driving signals comprises:
producing and outputting the two control signals by the control unit, when the level value of the first driving signal is valid and the second driving signal is at a low level, wherein a duty ratio of a first control signal is larger than a duty ratio of a second control signal.

3. The method according to claim 2, wherein the step of producing and outputting the two control signals by the control unit, when the level value of the first driving signal is valid and the second driving signal is at a low level comprises:
producing and outputting the two control signals by the control unit according to different working cycles, during a plurality of periods when the level value of the first driving signal is valid and the second driving signal is at a low level.

4. The method according to claim 1, wherein the step of producing and outputting two control signals by the control unit according to two driving signals comprises:
producing and outputting the two control signals by the control unit, when the level value of the first driving signal is valid and the second driving signal is at a high level, wherein a duty ratio of a first control signal is smaller than a duty ratio of a second control signal.

5. The method according to claim 4, wherein the step of producing and outputting the two control signals by the control unit, when the level value of the first driving signal is valid and the second driving signal is at a high level comprises:
producing and outputting the two control signals by the control unit according to different working cycles, during a plurality of periods when the level value of the first driving signal is valid and the second driving signal is at a high level.

6. A control method of signal transmission, applied to a transmitting module in a signal transmission system, wherein the transmitting module comprises a control unit, a full-bridge power unit, a transmitting coil, and a current detecting unit, wherein the transmitting coil is connected between midpoints of two bridge arms of the full-bridge power unit, and a current sampling point of the transmitting coil is connected to the control unit through the current detecting unit; and the method comprises:
producing and outputting two control signals by the control unit according to two driving signals, and controlling the full-bridge power unit according to the two control signals to generate a coil current by the transmitting coil, wherein when a level value of a first driving signal is valid and a second driving signal jumps once each time, an initial level of the two control signals switches once;
outputting an overcurrent signal to the control unit when the current detecting unit detects that the coil current is larger than a first current threshold;
controlling a control signal of a high level to jump to a low level by the control unit according to the overcurrent signal, maintaining a level of a control signal of a low level unchanged, and controlling the full-bridge power unit to reduce the coil current according to new two control signals to adjust a signal to be transmitted;
outputting an undercurrent signal to the control unit when the current detecting unit detects that the coil current drops below a second current threshold; and
controlling the control signal which jumps to the low level to jump to a high level again by the control unit according to the undercurrent signal, maintaining the control signal of the low level at the low level continuously, and controlling the full-bridge power unit to increase the coil current according to new two control signals to adjust the signal to be transmitted again.

7. The method according to claim 6, when the level value of the first driving signal is valid and the second driving signal is at a low level, a first control signal of the two control signals is at a high level and a second control signal is at a low level; and a step of controlling a level jumping of the control signal of the high level by the control unit according to the overcurrent signal, maintaining the level of the control signal of the low level unchanged comprises:
controlling the first control signal to jump to a low level by the control unit according to the overcurrent signal, maintaining the second control signal at the low level; and
the step of controlling the control signal which jumps to the low level to jump to a high level again by the control unit according to the undercurrent signal, maintaining the control signal of the low level at the low level continuously comprises:
controlling the first control signal to jump to the high level again by the control unit according to the undercurrent signal, and maintaining the second control signal at the low level continuously.

8. The method according to claim 6, when the level value of the first driving signal is valid and the second driving signal is at a high level, a first control signal of the two control signals is at a low level and a second control signal is at a high level; and a step of controlling a level jumping of the control signal of the high level by the control unit according to the overcurrent signal, maintaining the level of the control signal of the low level unchanged comprises:
controlling the second control signal to jump to a low level by the control unit according to the overcurrent signal, and maintaining the first control signal at the low level; and
the step of controlling the control signal which jumps to the low level to jump to a high level again by the control unit according to the undercurrent signal, maintaining the control signal of the low level at the low level continuously comprises:
controlling the second control signal to jump to the high level again by the control unit according to the undercurrent signal, and maintaining the first control signal at the low level continuously.

9. A selection method of signal transmission control mode, applied to a control unit in a transmitting module, wherein the transmitting module comprises a control unit, a full-bridge power unit, a transmitting coil, and a current detecting unit, wherein the transmitting coil is connected between midpoints of two bridge arms of the full-bridge power unit, and a current sampling point of the transmitting coil is connected to the control unit through the current detecting unit; the signal transmission control mode comprises a first control mode and a second control mode; and the method comprises:
selecting a target control mode from the first control mode and the second control mode by the control unit according to a working condition of the transmitting module, wherein
when the target control mode is the first control mode, the control unit is configured to perform the control method of signal transmission according to claim 1; and when the target control mode is the second control mode, the control unit is configured to perform the control method of signal transmission according to claim 6.

10. A transmitting module, wherein the transmitting module comprises a control unit, a full-bridge power unit, a transmitting coil, and a current detecting unit, wherein the transmitting coil is connected between midpoints of two bridge arms of the full-bridge power unit, and a current sampling point of the transmitting coil is connected to the control unit through the current detecting unit; and the transmitting module is configured to perform the control method of signal transmission according to claim 1, or to perform the control method of signal transmission according to claim 6.

11. A signal transmission system, wherein the signal transmission system comprises a receiving module and the transmitting module according to claim 10.
